(19) United States
(12) Patent Application Publication
(10) Pub. No.: US 2004/0081190 A1
(43) Pub. Date: Apr. 29, 2004

(54) Router redundancy system and method

(75) Inventor: Young Suck Kim, Seoul (KR)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(73) Assignee: LG Electronics Inc.

(21) Appl. No.: 10/627,486

(22) Filed: Jul. 25, 2003

(30) Foreign Application Priority Data
Jul. 26, 2002 (KR) 2002-44323

(51) Int. Cl. H04L 12/54

(52) U.S. Cl. 370/428

(57) ABSTRACT

A router apparatus in accordance with one or more embodiments of the invention is provided. In one embodiment, routing information of a first unit is mirrored to a second unit in real time, wherein at least one of the first unit and the second unit comprises at least one switching unit for transferring the routing information from the first unit to the second unit, eliminating use of a PCI-to-PCI board to complete transferring the routing information. When the routing information is stored in a first memory of a first switching unit, and the first switching unit transfers the information to the second unit. A second switching unit receives the routing information from the first switching unit and stores the routing information in a second memory of the second unit.

### CROSS-REFERENCE TO RELATED APPLICATIONS

Pursuant to 35 U.S.C. § 119(a), this application claims the benefit of earlier filing date and right of priority to the Korean Application No. 2002-44323, filed on Jul. 26, 2002, the content of which is hereby incorporated by reference herein in its entirety

### BACKGROUND OF THE INVENTION

1. Field of the Invention

The present invention relates to a routing system and, more particularly, to a router redundancy system and method.

2. Description of the Background Art

A router is a device for checking a destination address of a packet being transferred through a network and transferring the packet via the most suitable communication path. For duplexing (i.e., to provide data redundancy backup) for an active board (i.e., a first unit), generally, the router includes a standby board (i.e., a second unit) in case of a failure of the active board. Herein after, the terms active board and standby board, are interchangeably used instead of a first unit or a second unit, respectively.

The invention, in accordance with one or more embodiments, is disclosed as applicable to an active board and standby board. This application, however, is by way of example. As such, the invention should not be construed as limited to active and standby boards in a routing system. In alternative embodiments, the methods and implementation disclosed here may be applicable to other system components and units that can benefit from data redundancy features.

The router periodically duplicates/mirrors data stored in a memory of the active board to a memory of the standby board. That is, mirroring or redundancy means are provided for storing the same data in two or more units in order to prevent a data loss due to failure of equipment. FIG. 1 illustrates a construction of a router duplexing apparatus in accordance with conventional art, showing a path of mirroring a NVRAM data of an active board to a standard board.

Memory units 10A and 10B store log information and configuration information (e.g., IP addresses of each router interface, a sub-net mask, an access list). The memory units, generally, include a nonvolatile random access memory (NV RAM). The NV RAM is a memory device for preserving stored data even if power is cut off from an external source.

As shown in FIG. 1, a north bridge 40A of the active board reads data stored in the memory unit 10A (referred to as ‘memory data’, hereinafter), and transfers the data to a PCI-to-PCI bridge 50A (or an Ethernet controller). Then, the PCI-to-PCI bridge 50A outputs the memory data to the standby board. The memory data outputted from the active board is received by the standby board through a PCI-to-PCI bridge 50B, and a NORTH bridge 40B reads the memory data received by the PCI-to-PCI bridge 50B and stores it in the standby memory 10B.

Due to the characteristics of the PCI-to-PCI bridge 50A, a certain time delay occurs when the memory data is transferred from the active board to the standby board. Therefore, as mentioned above, the conventional duplexing apparatus has the following problems.

For example, time is required for the periodical mirroring operation, and while the mirroring operation is performed, memory access of other elements is limited. In addition, when the memory of the active board is updated, it is preferred that the memory of the standby board is updated simultaneously. In the conventional art, however, because the communication between the active board and the standby board are made through the PCI-to-PCI bridges 50A and 50B (or the Ethernet controller), a real time mirroring is not possibly implemented.

As such, methods and systems are needed to overcome the shortcoming of the prior art systems.

### SUMMARY OF THE INVENTION

A router apparatus in accordance with one or more embodiments of the invention is provided. In one embodiment, routing information of an active board is mirrored to a standby board in real time, wherein at least one of the active board and the standby board comprises at least one switching unit for transferring the routing information from the active board to the standby board, eliminating use of a PCI-to-PCI board to complete transferring the routing information.

When the routing information is stored in a first memory of a first switching unit, and the first switching unit transfers the information to the standby board. A second switching unit receives the routing information from the first switching unit and stores the routing information in a second memory of the standby board.

The second switching unit prevents signal transmission form the standby board to the second memory, in certain embodiments. When the first memory is loaded, the first switching unit transfers any signal transferred from the active board to the standby board. The second switching unit prevents data from being loaded from the second memory.

In some embodiments, the active board comprises a first programmable switch and the standby board comprises a second programmable switch. The first and second switching units can be structural equivalents. Alternatively, the first and second switching units may be functional equivalents.

In accordance with another embodiment, a routing redundancy apparatus comprises an active board for storing routing information in a first memory and for simultaneously transferring the routing information to a standby board by using a first switching unit; and a standby board for receiving the routing information by way a second switching unit and storing it in a second memory.

While the routing information is stored in the second memory, the second switching unit prevents signal transmission to the second memory, and when the first memory is loaded, the first switching unit prevents signal transmission form the active board to the standby board. In some embodiments, the second switching unit of standby board prevents the second memory from being loaded.

In accordance with yet another embodiment, a data redundancy system comprises a first switching unit; a second switching unit; an active board comprising a first memory for storing routing information; and a standby board comprising a second memory for storing routing information transferred from the active board. In certain embodiments, the active board further comprises the first switching unit and the standby board further comprises the second switching unit. The routing information is transferred from the active board to the standby board via the first and second switching unit. Accordingly, the first switching unit causes the routing information stored in the first memory to be transferred to the second memory via the second switching unit.

In one or more embodiments, the first switching unit comprises at least one multiplexer; and at least one tristate output buffer in communication with the at least one multiplexer; wherein the first switching unit is configured to connect to a plurality of external devices to route a signal inputted from a first device to a second device, according to control information. The multiplexer is a 2:1 multiplexer comprising two input terminals; one output terminal; and one control terminal responsive to a select signal, for example.

When a select signal is in a first state, the at least one multiplexer outputs a first signal, and when the select signal is in a second state, the at least one multiplexer outputs a second signal. In one embodiment, the at least one tristate output buffer is connected to the output terminal of the at least one multiplexer, wherein when the select signal is equal to a first value, the tristate output buffer is in an output-enable state, and when the select signal is equal to a second value, the tristate output buffer is in an output-disable state.

In accordance with one embodiment, a method of providing data redundancy in a routing system having a first switching unit, a second switching unit, an active board comprising a first memory, and a standby board comprising a second memory, comprises loading the first memory with routing information received by the active board; transferring the routing information from the first board to the standby board via the first switching unit in communication with the second switching unit; and loading the second memory with the routing information. In some embodiments, when a select signal is in a first state, the at least one multiplexer outputs a first signal, and when the select signal is in a second state, the at least one multiplexer outputs a second signal.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates a related art routing duplexing apparatus;

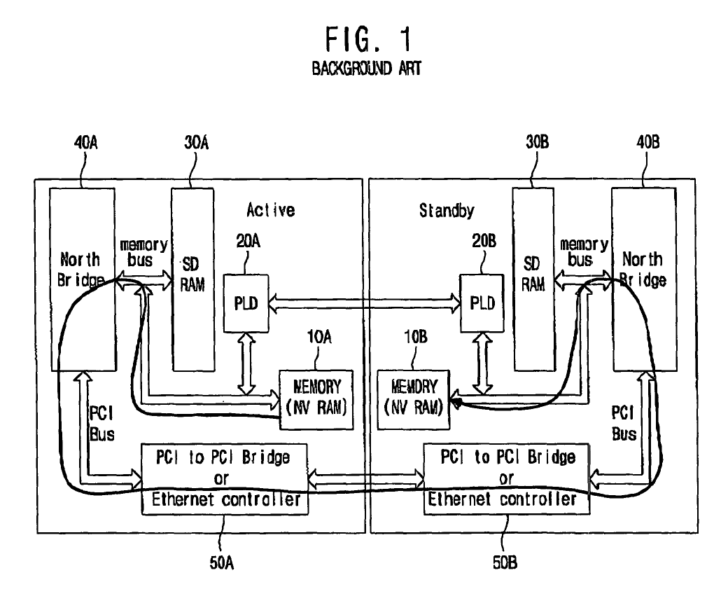

FIG. 2 illustrates a routing duplexing apparatus in accordance with one embodiment of the present invention;

FIG. 3 illustrates a structure of a device switch (GDX) in accordance with one embodiment;

FIG. 4 shows a routing information transfer path according to a write command in one embodiment; and

FIG. 5 shows a routing information transfer path, according to a read command.

Features, elements, and aspects of the invention that are referenced by the same numerals in different figures represent the same, equivalent, or similar features, elements, or aspects in accordance with one or more embodiments of the system.

### DETAILED DESCRIPTION OF THE PREFERRED EMBODIMENTS

Data switching and redundant information management systems and corresponding methods, according to one or more embodiments of the invention are provided. In a data switching method and system, a router sets a communication path on the basis of a memory data of a standby board and transfers data through the path. In the present invention, a real time mirroring operation is performed on the memory data so as for the router to set the most suitable communication path.

A router duplexing apparatus of the present invention is featured in that routing information of an active board is mirrored to a standby board in real time by using a plurality of switching units. The switching units are respectively provided both in the active board and the standby board.

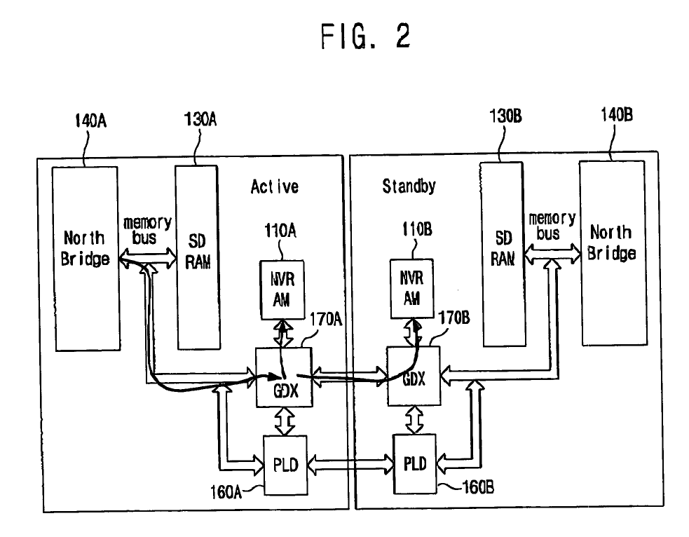

Referring to FIG. 2, the router duplexing apparatus of the present invention comprises switching units 170A and 170B, in one or more embodiments. The router duplexing apparatus comprises an active board for storing routing information in its memory 110A and transferring the information to a standby board by using general device switches GDX 170A, and a standby board for receiving the routing information by using a GDX 170B and storing it in its memory 110B.

The GDXs 170A and 170B are programmable switches for various circuits or communication equipments. Said programmable switches, in one embodiment comprise, for example, 5 multiplexers (m1˜m5) and tristate output buffers (b1˜b5). The GDX is connected in four sides to external devices that can freely route a signal inputted from each device according to a user's request.

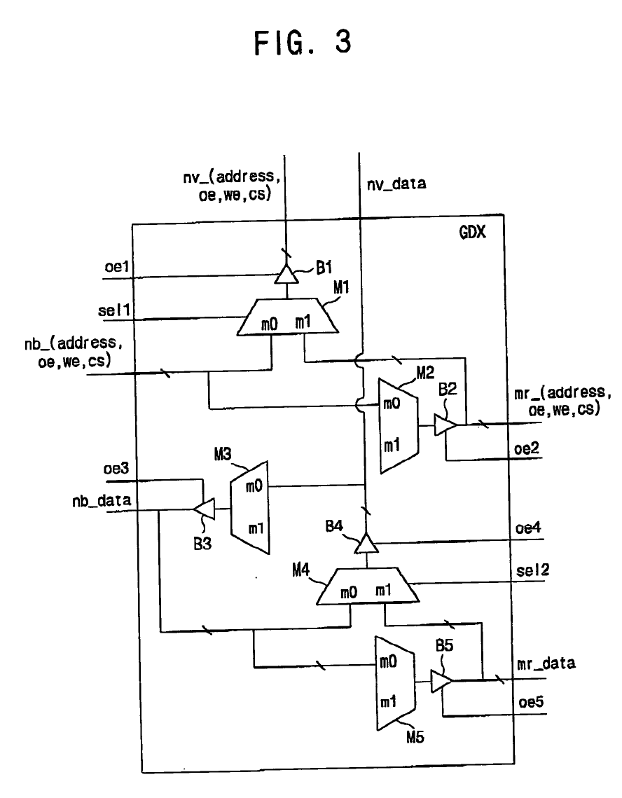

Referring to FIG. 3, the multiplexers (m1˜m5) provided in the GDX are 2:1 multiplexers each having two input terminals m0 and m1, one output terminal and one control terminal (select terminal), for example. When the select signal is ‘1’, the multiplexers m1˜m5 output a signal m0, and when the select signal ‘0’, the multiplexers m1˜m5 output a signal m1.

In the GDX, the five tristate output buffers b1˜b5 are respectively positioned at the output terminals of the multiplexers m1˜m5, and respectively have an input terminal, an output terminal and a control terminal (oe). When the signal oe is ‘1’, the tristate output buffers b1˜b5 are in an output-enable state, while when the signal oe is ‘0’, the tristate output buffers b1˜b5 are in an output-disable state, for example.

The GDX 170A comprises a multiplexer m1 for selectively outputting output signals (nb_(address, oe, we, cs)) of the NORTH bridge 140A or output signals (mr_(address, oe, we, cs)) of the GDX 170B according to a signal sel1; a buffer b1 for determining whether to output the output signal of the multiplexer m1 to the memory 110A according to a signal oe1; a multiplexer m2 for receiving output signals (nb_(address, oe, we, cs)) of the NORTH bridge 140A; a buffer b2 for determining whether to output the output signal of the multiplexer m2 to the GDX 170B according to a signal oe2; a multiplexer m3 for receiving a data signal (nv_data) of the memory 10A; a buffer b3 for determining whether to output the output signal of the multiplexer m3 to the NORTH bridge 140A according to a signal oe3; a multiplexer m4 for selectively outputting an output signal (nb_data) of the NORTH bridge 140A and an output signal (mr_data) of the GDX 170B according to a signal sel2; a buffer b4 for determining whether to output the output signal of the multiplexer m4 to the memory 110A according to a signal oe4; a multiplexer m5 for receiving the output signal (nb_data) of the NORTH bridge 140A; and a buffer b5 for determining whether to the output signal of the multiplexer m5 to the GDX 170B according to a signal oe5.

In one embodiment, the GDX 170B has, for example, the same construction and operation as the GDX 170A. The router duplexing apparatus in accordance with the present invention will now be described in detail. First, each programmable logic device (PLD) 160A and 160B checks a state of the board to which itself belongs, and sets one main board as an active board and the other as a standby board according to the check result. If the board to which the PLD 60A belongs is determined as an active board, the PLD 60A extracts control signals (cs/, oe/ and we/) for the memory 110A from the memory bus between the north bridge 140A and the synchronous dynamic random access memory (SDRAM) 130A.

If the extracted control signals (cs/, oe/ and we/) are a write command signal, the PLDs 160A and 160B control the GDXs 170A and 170B to set control signals oe1˜oe5 and sel1˜sel2 for the multiplexers m1˜m5 and the tristate output buffers b1˜b5 as shown in below Table 1:

TABLE 1

| | GDX (170A) | GDX (170B) |
|---|---|---|
| oe1 | 1 | 1 |
| oe2 | 1 | 0 |
| oe3 | 0 | 0 |
| oe4 | 1 | 1 |
| oe5 | 1 | 0 |
| sel1 | 0 | 1 |
| sel2 | 0 | 1 |
| oe/ | H | H |
| we/ | L | L |
| cs/ | L | L |

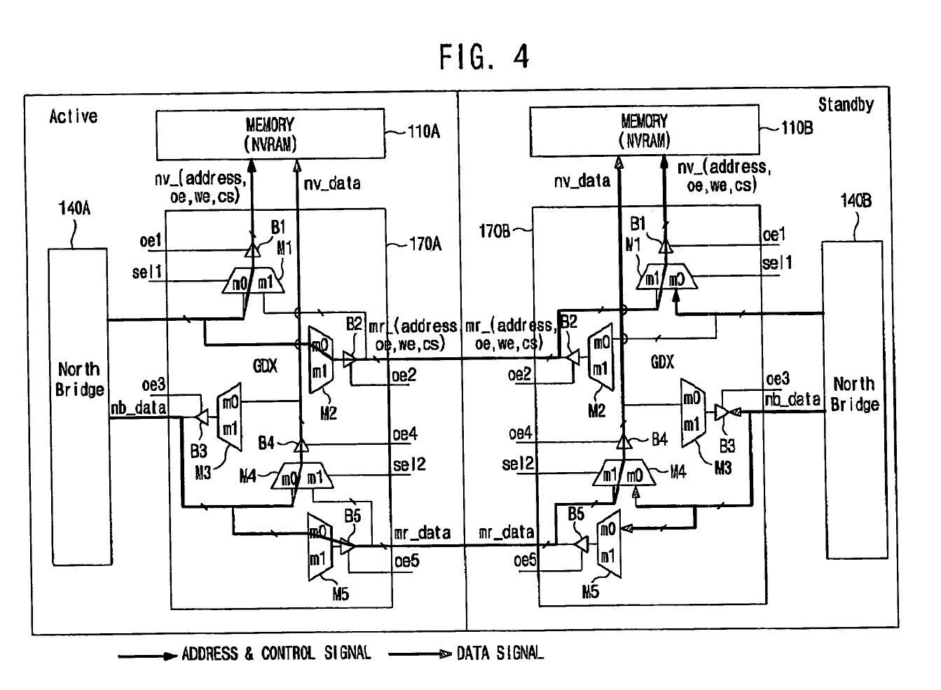

FIG. 4 shows a routing information transfer path according to a write command. If the control signals (cs/, oe/ and we/) extracted from the memory bus indicate a write command signal, a signal transfer path is set in the GDX 170A as shown in FIG. 4, through which routing information (nb_(address, oe, we, cs) & nb_data) of the north bridge 140A is transferred to the memory 110A and simultaneously to the standby board.

For example, the routing information (nb_(address, oe, we, cs) & nb_data) transferred to the standby board is stored in the memory 110B through the GDX 170B. At this time, the GDX 170B interrupts a signal, if any, transmitted from the north bridge 140B to the memory 110B. Meanwhile, after the active board and the standby board are determined, the control signals (cs/, oe/ and we/) extracted form the memory bus are read command signals, the PLDs 60A and 60B controls the GDXs 170A and 170B to set the control signals (oe1˜oe5, sel1˜sel2) for the multiplexers m1˜m5 and the tristate output buffers b1˜b5.

TABLE 2

| | GDX (170A) | GDX (170B) |
|---|---|---|
| oe1 | 1 | 0 |
| oe2 | 0 | 0 |
| oe3 | 1 | 0 |
| oe4 | 0 | 0 |
| oe5 | 0 | 0 |
| sel1 | 0 | X |
| sel2 | X | X |
| oe/ | L | L |
| we/ | H | H |
| cs/ | L | L |

X: Don't care

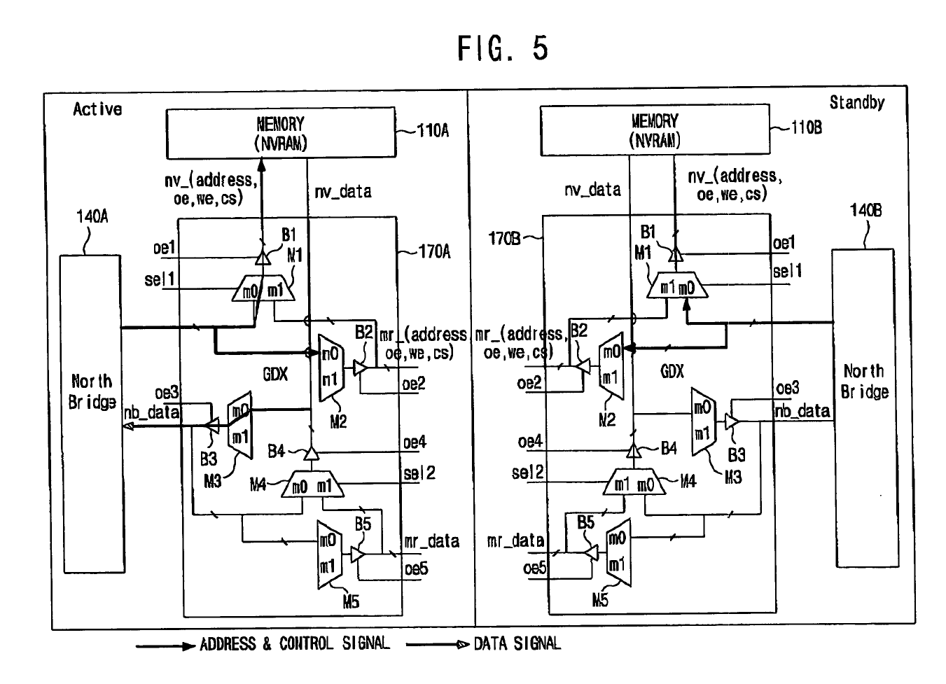

FIG. 5 shows a routing information transfer path according to a read command. If the control signals (cs/, oe/ and we/) extracted from the memory bus indicate a read command signal, a signal transfer path is set in the GDX 170A as shown in FIG. 5 and the routing information (nb_(address, oe, we, cs) & nb_data) of the active board is not transferred to the standby board. Also, the read command signal outputted from the north bridge 140B is not transmitted to the memory 110B.

In one embodiment, when the router reads the memory of the active board, the signal paths in the GDX 170A and the GDX 170B are set as shown in FIG. 5. Accordingly, data of the memory 110A and the memory 110B are not simultaneously outputted, preventing data collision. As so far described, the router duplexing apparatus of the present invention by substituting the conventionally used PCI bridge (or the Ethernet protocol) with a programmable switch provides the following advantages.

A substantially real time mirroring is accomplished on routing information (or the memory data) of the active board and the signal transfer path in the router is simplified. In addition, when the duplex switching occurs, a routing path is set on the basis of the latest routing information, enhancing a reliability of the router duplexing apparatus.

The embodiments described above are to be considered in all aspects as illustrative only and not restrictive in any manner. Thus, other exemplary embodiments, system architectures, platforms, and implementations that can support various aspects of the invention may be utilized without departing to from the essential characteristics described herein. These and various other adaptations and combinations of features of the embodiments disclosed are within the scope of the invention. The invention is defined by the claims and their full scope of equivalents.

What is claimed is:

1. A router apparatus wherein routing information of a first unit is mirrored to a second unit in real time, wherein at least one of the first unit and the second unit comprises at least one switching unit for transferring the routing information from the first unit to the second unit, substantially eliminating a delay associated with use of a PCI-to-PCI board for transferring the routing information.

2. The apparatus of claim 1, wherein when the routing information is stored in a first memory of a first switching unit, and wherein the first switching unit transfers the information to the second unit.

3. The apparatus of claim 2, wherein a second switching unit receives the routing information from the first switching unit and stores the routing information in a second memory of the second unit.

4. The apparatus of claim 3, wherein the second switching unit prevents signal transmission form the second unit to the second memory.

5. The apparatus of claim 2, wherein when the first memory is loaded, the first switching unit transfers any signal transferred from the first unit to the second unit.

6. The apparatus of claim 5, wherein the second switching unit prevents data from being loaded from the second memory.

7. The apparatus of claim 1, wherein the first unit comprises a first programmable switch and the second unit comprises a second programmable switch.

8. The apparatus of claim 7, wherein the first and second switching units are structural equivalents.

9. The apparatus of claim 7, wherein the first and second switching units are functional equivalents.

10. A routing redundancy apparatus comprising:
a first unit for storing routing information in a first memory and for simultaneously transferring the routing information to a second unit by using a first switching unit; and
a second unit for receiving the routing information by way a second switching unit and storing it in a second memory.

11. The apparatus of claim 10, wherein while the routing information is stored in the second memory, the second switching unit prevents signal transmission to the second memory.

12. The apparatus of claim 10, wherein when the first memory is loaded, the first switching unit prevents signal transmission form the first unit to the second unit.

13. The apparatus of claim 12, wherein the second switching unit of second unit prevents the second memory from being loaded.

14. The apparatus of claim 10, wherein the first and second switching units are programmable switches.

15. The apparatus of claim 10, wherein the first and second switching units have substantially same structural configuration.

16. A data redundancy system comprising:
a first switching unit;
a second switching unit;
a first unit comprising a first memory for storing routing information; and
a second unit comprising a second memory for storing routing information transferred from the first unit.

17. The system of claim 16, wherein the first unit further comprises the first switching unit.

18. The system of claim 17, wherein the second unit further comprises the second switching unit.

19. The system of claim 18, wherein the routing information is transferred from the first unit to the second unit via the first and second switching units.

20. The system of claim 19, wherein the routing information stored in the first memory is transferred via the first and second switching units to the second memory.

21. The system of claim 16 wherein the first switching unit comprises:
at least one multiplexer; and
at least one tristate output buffer in communication with the at least one multiplexer;
wherein the first switching unit is configured to connect to a plurality of external devices to route a signal inputted from a first device to a second device, according to control information.

22. The system of claim 21, wherein the at least one multiplexer is a 2:1 multiplexer comprising:
two input terminals;
one output terminal; and
one control terminal responsive to a select signal.

23. The system of claim 22, wherein when the select signal is in a first state, the at least one multiplexer outputs a first signal, and when the select signal is in a second state, the at least one multiplexer outputs a second signal.

24. The system of claim 22, wherein the at least one tristate output buffer is connected to the output terminal of the at least one multiplexer, wherein when the select signal is equal to a first value, the tristate output buffer is in an output-enable state, and when the select signal is equal to a second value, the tristate output buffer is in an output-disable state.

25. A method of providing data redundancy in a routing system having a first switching unit, a second switching unit, a first unit comprising a first memory, and a second unit comprising a second memory, the method comprising:
loading the first memory with routing information received by the first unit;
transferring the routing information from the first board to the second unit via the first switching unit in communication with the second switching unit; and
loading the second memory with the routing information.

26. The method of claim 25, wherein the first unit further comprises the first switching unit.

27. The method of claim 26, wherein the second unit further comprises the second switching unit.

28. The method of claim 25, wherein the first switching unit comprises:
at least one multiplexer; and
at least one tristate output buffer in communication with the at least one multiplexer;
wherein the first switching unit is configured to connect to a plurality of external devices to route a signal inputted from a first device to a second device, based on control signals.

29. The method of claim 25, wherein the at least one multiplexer is a 2:1 multiplexer comprising:
two input terminals;
one output terminal; and
one control terminal responsive to a select signal.

30. The method of claim 29, wherein when a select signal is in a first state, the at least one multiplexer outputs a first signal, and when the select signal is in a second state, the at least one multiplexer outputs a second signal.
